(19) United States
(12) Patent Application Publication
(10) Pub. No.: US 2016/0090447 A1
(43) Pub. Date: Mar. 31, 2016

(54) Continuous Process For The Preparation Of Polyoxazolines

(71) Applicant: BASF SE, Ludwigshafen (DE)

(72) Inventors: Fatemeh Ahmadnian, Ludwigshafen (DE); Valeria Zakharova, Mannheim (DE); Hans-Michael Walter, Freinsheim (DE); Andreas Brodhagen, Tiefenthal (DE); Holger Türk, Mannheim (DE)

(21) Appl. No.: 14/892,334

(22) PCT Filed: May 6, 2014
(86) PCT No.: PCT/EP2014/059257

§ 371 Date: Nov. 19, 2015

(30) Foreign Application Priority Data
May 29, 2013 (EP) 13169765.8

(51) Int. Cl. C08G 69/00; B01J 19/24; C08G 69/48

(52) U.S. Cl. CPC C08G 69/00; C08G 69/48; B01J 19/242; B01J 2219/24

(57) ABSTRACT

A continuous process for the preparation of polyoxazolines comprises mixing monomers, an initiator, and optionally an additive, feeding the mixture into at least one tubular reactor segment with a feed side and an outlet side, and polymerizing the mixture to form the polyoxazolines. A tubular reactor segment comprises a mixer for forming a mixture comprising monomers, an initiator, an additive, a terminating agent, and/or a functionalizing agent, at least first and second tubular reactor segments, and addition devices for the first and second tubular reactor segments.

The invention relates to a continuous process for the preparation of polyoxazolines comprising at least one tubular reactor segment with a feed side and an outlet side, the polyoxazolines obtainlable by such a process and a tubular reactor segment.

Polyoxazolines have been subject of a considerable amount of research since the 1960s and processes for the preparation of polyoxazolines are known in the art. Typically polyoxazolines are synthesized in a batch-type process (see Prog. Polym. Sci. 21 (1996), 151). A serious disadvantage of the cationic ring-opening polymerization of oxazolines in batch-type processes are the long reaction times. Usually several hours are required for the preparation of polyoxazolines with processes known in the art. Therefore, polyoxazolines obtained in batch processes, which are characterized by limited process parameters, are restricted in their structure variations. For the preparation of structurally more diverse polyoxazolines, microwave-assisted polymerization or batch synthesis under the pressure have been disclosed in Polymer 47 (2006), 75. However, these processes have the disadvantage that heat removal represents a considerable safety risk security aspect.

The document DE 1 904 540 also describes a continuous process for the polymerization of oxazolines in a screw type reactor comprising a rotating screw for mixing. The continuous preparation of polyoxazolines in screw type reactors is limited because only homopolymers and statistic polymers can be produced due to back-mixing and high shear is expected to damage the product, therefore making this process not economical.

As a result the nature of the polymer chains and their molecular weight distribution, which influence the structure and polarity of polymers, are difficult to control.

It is an object of the present invention to provide a continuous process for the preparation of polyoxazolines that permits reduced reaction times, a better space-time-yield and more flexible choice of the process parameters. In addition to this it is an object of the invention to provide polyoxazolines with a controlled polydispersity index, i.e. PDI (from very narrow, e.g. 1 to wide, e.g. 3) and the use of these polymers.

These objects are achieved by a continuous process for the preparation of polyoxazolines comprising at least one tubular reactor segment with a feed side and an outlet side, wherein

(a) an oxazoline monomer (A) according to formula (I)

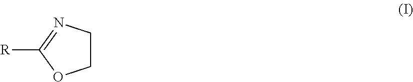

wherein R is selected from the group consisting of H, CN, NO₂, alkyl, alkenyl, aryl, heteroaryl or heterocyclyl,
and optionally at least one oxazoline monomer (B) according to formula (I), wherein the R of monomer (B) is selected from the group consisting of H, CN, NO₂, alkyl, alkenyl, aryl, heteroaryl or heterocyclyl but is different from the R of monomer (A),
is/are mixed with an initiator (C) and optionally an additive (D) to form a mixture,

(b) the mixture is fed into the tubular reactor segment via the feed side, and

(c) the mixture is polymerized in said tubular reactor segment to form the polyoxazolines.

This continuous process can be used to prepare either homopolymers if only an oxazoline monomer (A) is added in step (a) or random copolymers if an oxazoline monomer (A) and at least one oxazoline monomer (B) according to formula (I), wherein the R of monomer (B) is selected from the group consisting of H, CN, NO₂, alkyl, alkenyl, aryl, heteroaryl or heterocyclyl but is different from the R of monomer (A), are added in step (a). Optionally at least one oxazoline monomer (B) wherein the R of monomer (B) is selected from the group consisting of H, CN, NO₂, alkyl, alkenyl, aryl, heteroaryl or heterocyclyl but is different from the R of monomer (A) means that either one oxazoline monomer (B) having a defined structure, e.g. R is a methyl group, is added or more than one oxazoline monomer (B) having different structures, e.g. monomer with R being methyl and monomers with R being ethyl (as long as their structure differs from the structure of oxazoline monomer A), are added.

Preferably, the inventive continuous process for the preparation in a tubular reactor of polyoxazolines is characterized by a rise in the space-time yield, in particular 2-50 times. Also the preparation of the inventive polyoxazolines consumes less space, because the tubular reactor is smaller than the processes run in batch variations and there is no foaming issue as they can be run hydraulically filled. Hydraulically filled can be understood in the sense of the present invention that the reactor is completely filled with liquid and thus a gas phase is avoided. Since in the inventive process no gas phase occurs, no condensation of monomer or solvent can take place during the process. Therefore a homogenous mixture can be obtained in this continuous process. In addition to this, the temperature and the pressure can be raised in comparison to batch processes.

The following oxazolines monomers (A) and (B) according to formula (I):

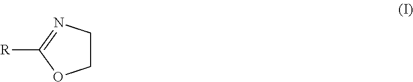

wherein R is selected from the group consisting of H, CN, NO₂, linear or branched alkyl, linear or branched alkenyl, aryl, heteroaryl or heterocyclyl can be used in the continuous process of the present invention. In a preferred embodiment, in the above formula (I), R is selected from the group consisting of H, linear or branched C₁-C₂₀ alkyl, linear or branched C₁-C₂₀ alkenyl or C₆-C₁₈ aryl. In a more preferred embodiment the oxazoline monomer is selected from the group consisting of methyl oxazoline, ethyl oxazoline, propyl oxazoline, isopropenyl oxazoline, butyl oxazoline, phenyl oxazoline, undecyl oxazoline, dodecyl oxazoline, stearyl oxazoline. In an even more preferred embodiment, the oxazoline monomer is 2-ethyl-2-oxazoline.

The oxazoline monomers (A) and (B) can be chosen from the above embodiments, however the chemical structure of monomer (A) must differ from the chemical structure of monomer (B). Therefore, the R of monomer (B) according to formula (I), which is selected from the group consisting of H, CN, NO₂, alkyl, alkenyl, aryl, heteroaryl or heterocyclyl must be different from the R of monomer (A). For example, when the R of monomer (A) is a methyl group, the monomer (B) must not have as R a methyl group and the R of monomer (B) must then be selected from any of the above described R except methyl.

According to the present invention, the initiator (C) is a strong electrophile. Preferably, the initiator (C) is selected from the group consisting of a weak Lewis acid, strong protic acid, an alkyhalide, a strong acid ester or a mixture thereof. Even more preferably, the initiator (C) is an ester of strong acid, as for example, alkylsulfate, alkylsulfonate (e.g. dimethylsulfate, methyltosylate, methyltriflate) or alkylhalide (e.g. benzyl chloride, benzyl iodide or benzyl bromide, 1,4-dibromo-2-butene). Salts of such electrophiles with oxazoline, as for example N-Methyl-2-alkyloxazolinium methylsulfate, p-toluenesulfonate, iodide or perchlorate or bifunctional initiators such as salts of electrophiles with bisoxazoline, to form B-A-I-A-B-type block copolymers, can also be used directly as initiator (C). The initiating group can be attached to a low molecular weight molecule and to a polymeric molecule. In a most preferred embodiment, the initiator (C) is N-methyl-ethyloxazoline-methylsulfate.

In an alternative embodiment, the initiator (C) is a multifunctional molecule carrying two or more of the above described strongly electrophilic groups. Using multifunctional initiators gives access to B-A-I-A-B-type block copolymers or I(A)n or I(A-B)n star polymers (wherein I is the initiator and n an integer from 3 to 1000 (e.g. when the multifunctional Initiator is a polymer with initiatiing side groups), preferably from 3 to 10 (e.g. when the multifunctional initiator is low-molecular, e.g. sugar based).

In a further embodiment, the initiating group as defined above is attached to a molecule (moiety) which contains further functional groups. These functional groups do not interfere with the oxazoline polymerization and are available for further chemical reactions after the polymerization has been completed. Thereby, further polymeric entities can be added to the polyoxazoline polymer obtainable by the process of the present invention. Thus, in a preferred embodiment, the initiator as defined above additionally has a functional group such as a vinyl group, preferably a styrene group. In a more preferred embodiment, the initiator (C) is vinyl benzylchloride.

In the sense of the present invention a stream can be understood as a compound in liquid form, whereby the component is moved under force. This movement can be carried out, for example by a pump. The stream can also be a mixture of compounds, in particular with solvents.

In a further embodiment of the present invention, the tubular reactor segment can also be filled with Raschig rings.

In a preferred embodiment, the at least one tubular reactor segment with a feed side and an outlet side can have a recycle stream which is removed from the outlet side of the tubular reactor segment and recycled to the inlet side of the tubular reactor segment.

In a preferred embodiment of the continuous process the polymerization takes place in at least two tubular reactor segments connected in series. The polymerization process according to the present invention can be carried out in various types of tubular reactor segments, for example of a different type or length.

In a preferred embodiment of the continuous process at least two tubular segments are connected in series, wherein the first tubular reactor segment has a first feed side and a first outlet side, wherein the first tubular reactor segment is connected to a second tubular reactor segment via the first outlet side that corresponds to a second feed side of the second tubular segment and whereby optionally at least one recycle stream is removed from the outlet side of at least one tubular reactor segment and recycled to the inlet side of one of the tubular reactor segments. For example, tubular reactor segments can be connected in series, whereby one recycle stream is removed from the outlet side of the second tubular reactor segment and recycled to the feed side of the first or the second tubular reactor segment. In a further embodiment, two tubular reactor segments can be connected in series, whereby one recycle stream is removed from the outlet side of the first tubular reactor segment and recycled to the feed side of first tubular reactor segment. In the sense of the present invention one recycle stream can be understood as one loop.

In a further preferred embodiment, the process described above comprises at least two tubular segments are connected in series, wherein the first tubular reactor segment has a first feed side and a first outlet side, wherein the first tubular reactor segment is connected to a second tubular reactor segment via the first outlet side that corresponds to a second feed side of the second tubular segment and wherein the process further comprises the following steps:
(d) at least one oxazoline monomer (B) according to formula (I), wherein the R of monomer (B) is selected from the group consisting of H, CN, NO₂, alkyl, alkenyl, aryl, heteroaryl or heterocyclyl but is different from the R of monomer (A) or an oxazoline monomer (A), and optionally an additive (D) is/are fed via the second feed side of the second tubular reactor segment into the second tubular reactor segment thereby forming a mixture and
(e) the mixture is polymerized in the second tubular reactor segment with the polymer of step (c) streaming from the first outlet side that corresponds to the second feed side of the second tubular reactor segment into said second tubular reactor segment.

Such a process can be used to prepare either block copolymers based on oxazolines or block copolymers based on oxazolines and other polymeric entities as described herein. In accordance with the present invention, further oxazoline monomers according to formula (I) can be added and polymerized in subsequent tubular reactor segments in the same manner as described above. Thereby, polyoxazoline polymers with different blocks or with blocks and random copolymers can be obtained. The process of the present invention is very flexible and any conceivable polyoxazoline polymer is obtainable by said process.

In a preferred embodiment, the polymer is reacted with a termination agent (E) or a functionalizing agent (F) as defined below. Terminating agents (E) are capable of terminating the living chain of the polymer obtainable by the process of the present invention. Functionalizing agents (F) are capable of introducing functional end-groups which are available for further chemical reactions at the chain ends, e.g. for further polymerization reactions.

In an alternative embodiment, the process described above further comprises the following steps:
(d) the polymer stream generated in step (c) in the first tubular reactor segment streams from the first outlet side of the first tubular reactor segment that corresponds to a second feed side of a second tubular reactor segment into said second tubular reactor segment for cooling;
(e) a terminating agent (E) or a functionalizing agent (F) and optionally an additive (D) is added to the stream via a third feed side of a third tubular reactor segment into said third tubular reactor segment and
(f) the polymer stream of step (d) streams from the second outlet side that corresponds to the third feed side of the third tubular reactor segment into said third tubular reactor segment and the polymer of the polymer stream is terminated in the third tubular reactor segment with the terminating agent (E) or the functionalizing agent (F).

The polymerization process is considered to be a “living polymerization”. In living polymerizations, the polymerization of the monomer progresses until the monomer is virtually exhausted and upon addition of further monomer or a different monomer, the polymerization resumes. In living polymerization, the degree of polymerization and hence the molecular weight can be controlled by the monomer and initiator concentrations. This allows for the synthesis of well-defined species with a narrow molecular weight distribution as well as block polymers with controlled block lengths, of random copolymers, graft polymers, comb polymers, star polymers, polymers with functional end-groups including, but not limited, to macromonomers and telechelic polymers.

The initiator (C) is preferably applied in amount from 0.001 to 20 mol % related to the amount of the oxazoline monomer (A) used for polymerization.

Terminating agents (E) can be used to terminate the living chain of the polymer obtainable by the process of the present invention. As a terminating agent (E) any nucleophile capable of terminating the living chain of the polymer can be used. It can be a low molecular weight compound or a polymer. In a preferred embodiment, the terminating agent (E) is selected from the group consisting of water, amine or amide-containing compound (e.g. alkyl-amine), anion of organic acid (e.g. triethylammonium methacrylate), thiol-derivative, alcohol-derivative or phenol-derivative. In a further preferred embodiment, the terminating agent (E) is methylcyclohexanamine.

Functionalizing agents (F) can be used to introduce functional end-groups which are available for further chemical reactions at the chain ends. In a preferred embodiment, the functionalizing agents have the following general formula (II):

HX—R¹—F (II)

wherein X is O, S, NH or NR²; R¹ and R² are independently alkylen or arylen; F is OH, COOH, NH₂ or CO.

Polymers carrying such functional end-groups A-F can be reacted with other functionalized polymers P-F′ to form block, graft or comb polymers linked via reaction of functional groups F and F′. For example: F=hydroxyl and F′=carboxyl=>A-ester-P

F=amino and F′=carboxyl=>A-amide-P

The polymer P can be an oxazoline polymer or it can be based on a different chemistry, such as polyalkoxide (PEG, etc.), polyester, polyamide, polycarbonate, vinyl polymer, etc.

In another preferred embodiment, the functionalizing agents (F) contain for instance functional end-groups such as: O—(C═O)—CH═CH₂, O—(C═O)—C(CH₃)═CH₂, O—CH═CH₂. More preferred functionalizing agents (F) are methacrylic acid or aminopropyl vinylether. Polymers carrying such end-groups are macromonomers which can be (co)polymerized via radical copolymerization.

In a further preferred embodiment, the functionalizing agents (F) are coupling agents. Such coupling agents carry at least two nucleophilic groups (diols, diamines, triols, triamines, glycerol, sorbitol, triethylenetetramine, tetraethylenepentamine, etc.). Coupling of living polymers leads to, e.g., A-B-B-A triblock copolymers or star polymers with at least three arms.

In a preferred embodiment of the continuous process the ratio of the recycle stream to the feed stream is between 1 and 1000, preferably by weight. Preferably, the ratio is between 2 and 200, in particular between 3 and 100 and especially preferred between 10 and 50. The feed stream is the stream, where the recycle stream enters.

In a preferred embodiment of the continuous process at least one feed side, one tubular reactor segment or one outlet side is equipped with a mixer, in particular with a static mixer. In the sense of the present invention equipped means that the mixer can be inside the feed side, the tubular reactor segment or the outlet side or that the mixer is connected to the feed side, the tubular reactor segment or the outlet side as a separate unit. In a suitable embodiment, static mixers have milli-structures which have at least one mixing channel. The mixing can proceed in a creeping, laminar, laminar-chaotic or turbulent manner. Milli-structures are defined by structures with cavities in the millimeter range, especially cavities between 0.1 mm to 50 mm, especially between 1 mm to 10 mm. In a further preferred embodiment, an oxazoline monomer (A) and optionally at least one oxazoline monomer (B) as defined above and/or an additive (D) are mixed in a tubular reactor segment and an initiator is added to this mixture after the outlet side of said tubular reactor segment and before a feed side of a subsequent tubular reactor segment via a T-junction, wherein the polymerization occurs in the subsequent tubular reactor. Such statis mixers prevent back-mixing and high shear of the polymers known to occur when screw type reactors and extruders are used for a polymerization process.

In laminar diffusion mixers, substreams of the fluid, which has been fanned out in a microstructure into a multitude of microscopically small flow lamellae with a thickness in the range from 10 to 2000 μm, especially from 20 to 1000 μm and in particular from 40 to 500 μm, are mixed exclusively by molecular diffusion at right angles to the main flow direction.

Laminar diffusion mixers can be configured as simple T or Y mixers or as so-called multilamination mixers. In the case of the T or Y mixer, the two (or else more than two) substreams to be mixed are fed to an individual channel through a T- or Y-shaped arrangement. What is crucial for the transversal diffusion path SDiff here is the channel width δK. Typical channel widths between 100 μm and 1 mm give rise to customary mixing times in the range from seconds to minutes for liquids. When, as in the present process, liquids are mixed, it is advantageous to promote the mixing operation additionally, for example by means of flow-induced transverse mixing.

In the case of multilamination mixers or interdigital mixers, the substreams to be mixed are divided in a distributor into a large number of microflow threads and, at the exit of the distributor, are then fed to the mixing zone alternately in lamellae. For liquids, mixing times in the range of seconds are achieved with the conventional multilamination mixers. Since this is insufficient for some applications (for example in the case of fast reactions), the basic principle has therefore been developed further by focusing the flow lamellae additionally by geometric or hydrodynamic means. The geometric focusing is achieved by a constriction in the mixing zone. The hydrodynamic focusing is achieved by two sidestreams which flow toward the main stream at right angles and thus further compress the flow lamellae. The focusing described allows lateral dimensions of the flow lamellae of a few micrometers to be achieved, such that even liquids can be mixed within a few 10 s of ms.

The laminar diffusion mixers with convective crossmixing used may be micromixers with structured walls. In the case of micromixers with structured walls, secondary structures (grooves or projections) are disposed on the channel walls. They are preferably arranged at a particular angle to the main flow direction, for example at an angle of from about 30° up to 90°. In the case of inertia-dominated flow conditions, secondary vortices form as a result, which support the mixing process.

In a further suitable embodiment, the mixer with microstructure used is a split-recombine mixer. Split-recombine mixers are notable for stages composed of recurrent separation and combination of streams. Two regions of an unmixed fluid stream (it is usual to start from two equally large lamellae) are each conducted away from one another in one stage, distributed into two new regions in each case, and combined again. All four regions are arranged alongside one another in alternation such that the original geometry is re-established. In each of these stages, the number of lamellae is thus doubled stage by stage and lamellar thickness and diffusion pathway are thus halved.

Examples of suitable split-recombine mixers are the caterpillar mixer from IMM and the caterpillar mixer from BTS-Ehrfeld.

Examples of suitable dynamic micromixers are, for example, micro-mixing pumps.

Examples of preferred static micromixers are especially the following laminar diffusion mixers: “chaotic-laminar” mixers, for example T or Y pieces with a very small capillary diameter in the range from 100 μm to 1500 μm and preferably from 100 μm to 800 μm at the mixing point, and cyclone mixers;

ultilamination mixers, for example the LH2 and LH25 slit plate mixers or larger types from Ehrfeld, and the interdigital mixers SIMM and Starlam(R) from IMM;

micromixers according to the multilamination principle with superimposed expanded flow, for example the SuperFocus Interdigital SFIMM microstructure mixer from IMM.

In particular preferred are mixers from SMX Mixers, Kenics, are any static mixers for example like those described in (Pahl, M. H. ; Muschelknautz, E.; Chem.-Ing.-Tech. 51 (1979), Nr. 5, S. 347/364).

The static mixers can also be of the type heat exchanger static mixers like those of the company Fluitec, Sulzer or Statiflo.

The Static mixers can be made of steel, or other metals, of Ceramic, out of Teflon or Polypropylene. The polymer static mixers can be reinforced with glass fibers.

The tubular reactor segment with a feed side and an outlet side can preferably be connected in series, whereby at least one segment can be different from the other. The different feature can be one of the above mentioned mixers or the segment dimension.

In a preferred embodiment of the continuous process at least one tubular reactor segment has a relationship of surface to volume from at least 10 m²/m³, preferably at least 30 m²/m³, more preferably at least 400 m²/m³, even more preferably at least 500 m²/m³. In another preferred embodiment, at least one tubular reactor segment has a relationship of surface to volume between at least 10 m²/m³ to 800 m²/m³, preferably between at least 30 m²/m³ to 800 m²/m³, more preferably between at least 400 m²/m³ to 800 m²/m³, even more preferably between at least 500 m²/m³ to 800 m²/m³. Preferably with this relationship, the components can be mixed homogeneously so that a statistical distribution is achieved.

In a preferred embodiment of the continuous process the temperature of the feed side is below the mean polymerization temperature. Thereby a clogging or blocking of the feed side can be reduced, ideally the stream rate keeps constant in the feed side and the tubular reactor segment. Thereby the temperature can be increased to start the polymerization after the components are statistically distributed.

In a preferred embodiment of the continuous process the ratio of the length of at least one tubular reactor segment in the direction of the flow of the stream to the diameter is from 1000:1 to 10:1, preferably from 500:1 to 15:1 and in particular from 80:1 to 20:1.

In a preferred embodiment of the continuous process at least one tubular reactor segment is a tubular reactor filled with milli-structured filling, preferably a static mixer. In particular all kind of tubes can be used, whereby the relationship of the lateral length to the diameter of the tube is in the range from 1.6 to 1000, preferably from 5 to 400. In particular the length of the tubular tube can be from 50 cm to 400 cm. The diameter of the tube can be from 0.1 mm to 35 cm. The millistructured filling in form of a static mixer prevents back-mixing and high shear of the polymers during the polymerization known to occur when screw type reactors and extruders are used for a polymerization process.

Reactors for use in accordance with the invention are preferably selected from jacketed tubular reactors, temperature-controllable tubular reactors, tube bundle heat exchangers, plate heat exchangers and temperature-controllable tubular reactors with internals.

In another embodiment the characteristic dimensions of the tube or capillary diameter in laboratory scale can be in the range from 0.1 mm to 25 mm, more preferably in the range from 0.5 mm to 6 mm, even more preferably in the range from 0.7 to 4 mm and especially in the range from 0.8 mm to 3 mm.

In another embodiment the characteristic dimensions of the tube or capillary diameter in industrial scale can be in the range from 0.05 m to 0.35 m, more preferably in the range from 0.1 m to 0.25 m.

Optionally, the tubular reactors may comprise mixing elements permeated by temperature control channels (for example of the CSE-XR(R) type from Fluitec, Switzerland).

In a preferred embodiment of the continuous process the polymerization time is up to 3 hours per tubular reactor segment. Because of the flexible choice of the process parameters the polymerization time is up to 3 hours per tubular reactor segment, whereby in contrast to the prior art in a batch process the polymerization times are significantly higher. This results in a better space-time-yield.

In a preferred embodiment of the continuous process the pressure in at least one tubular reactor segment is at least 2 bar, preferably between 2 and 10 bar, and in particular between 2 and 6 bar. Due to the large surface area per reaction volume in the new continuous process, heat transfer is faster and thus the process can be run at wide temperature range. As enough cooling is available through heat exchange with the cooling medium outside the reactor, no evaporative cooling is needed. This allows pressure variation without being limited by the evaporation point of monomers or solvents. For example, water or oil-like components can be used as cooling medium.

In a preferred embodiment of the continuous process the average residence time of at least one of the components (A), (B), (C), (D), (E) or (F) as defined above in at least one tubular reactor segment is in a range from 15 min to 180 min, preferably in the range from 30 min to 140 min, in particular from 60 min to 120 min.

In another embodiment the tubular reactor segments connected in series are heated that they exhibit an increasing heat gradient in the direction of the stream. Preferably the feed side and the outlet side are not heated by this gradient.

In a further preferred embodiment, the monomers are polymerized in at least one tubular reactor segment at a temperature between 70 and 250° C., preferably between 80 and 150° C., more preferably 90 and 120° C.

If more than one tubular reactor segment is used, the temperature may vary between the different tubular reactors segments.

The inventive polymerization reaction can be carried out in the presence of an additive (D). The additive is selected from the group consisting of surfactants, solvents, diluents, fillers, colorants, rheology modifiers, crosslinkers or emulsifiers or mixtures thereof.

In particular additives are solvents, which are also used to formulate the inventive polyoxazolines for use and can therefore remain in the polymerization product.

In a preferred embodiment, the solvent is an ester, an ether, a ketone, an aromatic or a nitrile. In a more preferred embodiment, the additive (D) is acetonitrile.

When an additive (D) is used as a diluent, generally from 1 to 40% by weight, preferably from 1 to 35% by weight, more preferably from 1.5 to 30% by weight, most preferably from 2 to 25% by weight, based in each case on the sum of the components (A), (B), (C), (E) and (F) used in the process, are used.

The additive (D) can also be added at the end of the process to the finished product.

If the additive (D) is a solvent, the solvent can also be removed in a final step of the process of the present invention by methods known in the art, by using e.g. a stripping column with a stripping agent, falling film evaporator, thin film evaporator, Wendell evaporator or any other type of evaporator with a high specific surface for heat removal and short residence time. In a preferred embodiment, the solvent is removed via evaporation.

The present invention also relates to a polyoxazoline obtainable by the process according to the present invention. These polyoxazolines have preferably a polydispersity M_{w}/Mₙ, whereas M_{w} refers to the weight average molecular weight and Mₙ refers to the number average molecular weight, between 1 and 3. Mₙ of such polyoxazolines is usually between 1,000 and 100,000, preferably 1,000 and 10,000 and more preferably 1,000 and 5,000. The polyoxazolines can be in the form of block polymers with controlled block lengths, random copolymers, graft polymers, comb polymers, star polymers, polymers with functional end-groups including, but not limited, to macromonomers and telechelic polymers etc.

The polyoxazolines obtainable by said process may find application in the pharmaceutical, adhesives, coatings, ink, agrochemicals, construction chemicals and many other fields. The polyoxazolines may be used e.g. as additives or coatings, inks or adhesives, solvent and water-borne dispersants for pigments, hot melt adhesives, protective colloids for emulsion polymerization, encapsulants for pharmaceuticals, encapsulants for agricultural active ingredients, adjuvants for agricultural active ingredients, solubilisers for agricultural active ingredients primers, precursors for antifouling materials, compatibilizers for plastics, glass fiber sizing agents, cosmetics, water treatment agents or as lubricants.

The present invention further relates to a tubular reactor segment, comprising:
a mixer for mixing an oxazoline monomer (A) as defined above, an initiator (C) and optionally an oxazoline monomer (B), or a terminating agent (E) or a functionalizing agent (F) and/or an additive (D) as defined above;
at least one tubular reactor segment with a feed side and an outlet side
at least one addition device, which is capable of adding said mixture into the tubular reactor segment at the first feed side of the tubular reactor segment
at least one addition device, which is capable of adding an oxazoline monomer (B), or a terminating agent (E) or a functionalizing agent (F) as defined above into the tubular reactor segment at the second feed side of the tubular reactor segment.

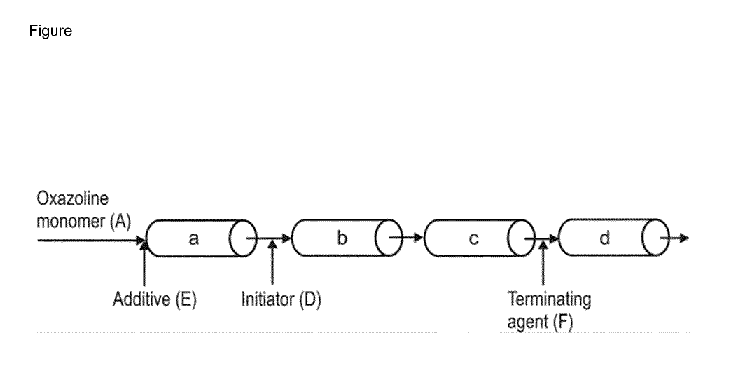

The present invention is illustrated with reference to FIG. 1 and the Examples, without limiting to these embodiments.

FIG. 1 is a schematic illustration of the tubular reactor segments a to d connected in series in accordance with in Example 1.

### EXAMPLES

Materials:

Oxazoline monomer (A): 2-ethyl-2-oxazoline

Additive (D): acetonitrile

Initiator (C): N-methyl-ethyloxazoline-methylsulfate (15% in acetonitrile)

Terminating agent (E): methyl-cyclohexanamin

Four tubular reactor segments denoted (a) to (d) were used to run the polymerization (see FIG. 1). The void volume of the tubular segment (b) is 62.45 ml and that of the tubular reactor segments (a), (c) and (d) is 125 ml each. These tubular reactor segments were filled with SMX static mixers from the company Fluitec. The pumps used in this setup were HPLC pumps supplied by the company Bischoff.

### Example 1

To the feed side of the tubular reactor segment (a), working as a premixer, one stream composed of 2-ethyl-2-oxazoline (oxazoline monomer (A)) with a flow rate of 17.36 g/h and one stream composed of acetonitrile (additive (D)) with a flow rate of 6.14 g/h were fed at room temperature. A stream composed of N-methyl-ethyloxazoline-methylsulfate (initiator (C)) (15% in acetonitrile) with a flow rate of 7.87 g/h was fed directly after the outlet side of the tubular reactor segment (a) and before the feed side of the tubular reactor segment (b) via a T-junction into the main feed stream. The polymerization took place in the tubular reactor segment (b) at 90° C. The outlet stream of the tubular reactor segment (b) was fed to the tubular reactor segment (c), where the polymer was cooled down to 25° C. A stream composed of methyl-cyclohexanamin (terminating agent (E)) with a flow rate of 0.6 g/h was fed directly after the outlet side of the tubular reactor segment (c) and before the feed side of the tubular reactor segment (d) via a T-junction into the main feed stream. The main feed stream was fed into the reactor segment (d) having a temperature of 25° C. The polymer was collected at the outlet side of the tubular reactor segment (d). The polymer was analysed via GPC and had an Mw of 4,850 g/mol and a PDI of 1.6 could be achieved.

1. A continuous process for the preparation of polyoxazolines comprising:
(a) forming a mixture comprising:
an oxazoline monomer (A) according to formula (I) 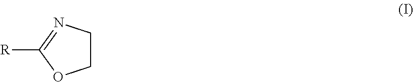
wherein R is selected from the group consisting of H, CN, NO₂, alkyl, alkenyl, aryl, heteroaryl or heterocyclyl, and optionally at least one oxazoline monomer (B) according to formula (I), wherein the R of monomer (B) is selected from the group consisting of H, CN, NO₂, alkyl, alkenyl, aryl, heteroaryl or heterocyclyl but is different from the R of monomer (A),
an initiator (C), and
optionally an additive (D) to form a mixture,
(b) feeding the mixture is as a feed stream into at least one tubular reactor segment having a feed side and an outlet side via the feed side, and
(c) polymerizing the mixture in the tubular reactor segment to form a polymer stream comprising polyoxazolines.

2. The continuous process according to claim 1, wherein the R is selected from the group consisting of: H, C₁-C₂₀ alkyl, C₁-C₂₀ alkenyl, or C₆-C₁₈ aryl.

3. The continuous process according to claim 1, wherein at least one recycle stream is removed from the outlet side of the at least one tubular reactor segment and recycled to the feed side of one of said at least one tubular reactor segments.

4. The continuous process according to claim 1, wherein at least two tubular segments are connected in series, wherein a first tubular reactor segment has a first feed side and a first outlet side, wherein first tubular reactor segment is connected to a second tubular reactor segment via the first outlet side that corresponds to a second feed side of the second tubular segment and wherein the process further comprises the following steps:
(d) feeding at least one oxazoline monomer (B) according to formula (I), wherein the R of monomer (B) is selected from the group consisting of H, CN, NO₂, alkyl, alkenyl, aryl, heteroaryl or heterocyclyl but is different from the R of monomer (A) or an oxazoline monomer (A), and optionally an additive (D) via the second feed side of the second tubular reactor segment into the second tubular reactor segment thereby forming a mixture and
(e) polymerizing the mixture in the second tubular reactor segment with the polymer of step (c) streaming from the first outlet side that corresponds to the second feed side of the second tubular reactor segment into said second tubular reactor segment.

5. The continuous process according to claim 1, wherein the process further comprises the following steps:
(d) streaming the polymer stream generated in step (c) in the first tubular reactor segment from the first outlet side of the first tubular reactor segment that corresponds to a second feed side of a second tubular reactor segment into said second tubular reactor segment for cooling;
(e) adding a terminating agent (E) or a functionalizing agent (F) and optionally an additive (D) to the polymer stream via a third feed side of a third tubular reactor segment into said third tubular reactor segment and
(f) streaming the polymer stream of step (d) from the second outlet side that corresponds to the third feed side of the third tubular reactor segment into said third tubular reactor segment and terminating the polymer in the third tubular reactor segment with the terminating agent (E) or the functionalizing agent (F).

6. The continuous process according to claim 1, wherein the process further comprising reacting the polymer of step (c) with a terminating agent (E) or a functionalizing agent (F).

7. The continuous process according to claim 3, wherein a ratio of the recycle stream to the feed stream is between 1 and 1000 by weight.

8. The continuous process according to claim 1, wherein the at least one tubular reactor segment has a relationship of surface to volume of at least 10 m²/m³.

9. The continuous process according to claim 1, wherein a ratio of the length of the at least one tubular reactor segment in the direction of the flow of the feed stream to the diameter is from 1000:1 to 10:1.

10. The continuous process according to claim 1, wherein the at least one tubular reactor segment is a tubular reactor filled with millistructured filling.

11. The continuous process according to claim 1, wherein a polymerization time is up to 3 hours per tubular reactor segment.

12. The continuous process according to claim 1, wherein an average residence time of at least one of the components (A), (B), (C), or (D) in the at least one tubular reactor segment is in the range of from 15 min to 180 min.

13. The continuous process according to claim 1, wherein the monomers are polymerized at a temperature of between 70 and 250° C.

14. The continuous process according to claim 1, wherein the mixture comprises the additive (D) comprising a solvent.

15. The continuous process according to claim 14, wherein the solvent is removed via evaporation.

16. A polyoxazoline obtainable by the process according to claim 1.

17. A tubular reactor comprising:
a mixer for forming a mixture comprising: an oxazoline monomer (A) according to formula (I) 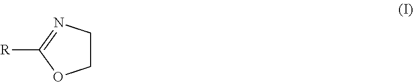
wherein R is selected from the group consisting of H, CN, NO₂, alkyl, alkenyl, aryl, heteroaryl or heterocyclyl, an initiator (C) and optionally an oxazoline monomer (B) according to formula (I), wherein the R of monomer (B) is selected from the group consisting of H, CN, NO₂, alkyl, alkenyl, aryl, heteroaryl or heterocyclyl but is different from the R of monomer (A), a terminating agent (E) or a functionalizing agent (F) and/or an additive (D);
at least a first one-tubular reactor segment with a first feed side and a first outlet side and a second tubular reactor segment with a second feed side and a second outlet side;
at least one addition device, which is capable of adding the mixture into the tubular reactor segment at the first feed side of the first tubular reactor segment; and
at least one addition device, which is capable of adding an oxazoline monomer (B), a terminating agent (E) or a functionalizing agent (F) into the second tubular reactor segment at the second feed side of the second tubular reactor segment.
